(19) United States
(12) Patent Application Publication
(10) Pub. No.: US 2020/0023338 A1
(43) Pub. Date: Jan. 23, 2020

(54) Novel Chromatography Media

(71) Applicant: GE Healthcare BioProcess R&D AB, Uppsala (SE)

(72) Inventors: Ann Catharina Bergh, Uppsala (SE); Tania Ahmad, Uppsala (SE); Mattias Algotsson, Uppsala (SE); Therese Graner, Uppsala (SE)

(73) Assignee: GE Healthcare BioProcess R&D AB, Uppsala (SE)

(21) Appl. No.: 16/337,236

(22) PCT Filed: Sep. 27, 2017
(86) PCT No.: PCT/EP2017/074459

§ 371 Date: Mar. 27, 2019

(30) Foreign Application Priority Data
Oct. 3, 2016 (GB) 1616758.7

(51) Int. Cl. B01J 20/289; B01D 15/38; B01J 20/28; B01J 20/32

(52) U.S. Cl. CPC B01J 20/289; B01D 15/3828; B01J 20/3265; B01J 20/28004; B01J 20/3219; B01J 20/28009

(57) ABSTRACT

The present invention relates to a novel chromatography media, more closely a novel IMAC (Immobilized Metal Affinity Chromatography) media. The novel chromatography media comprises a pentaligand and provides high dynamic binding capacity as well as high purity of the sample proteins purified on the media of the invention.

### FIELD OF THE INVENTION

The present invention relates to a novel chromatography media, more closely a novel IMAC (Immobilized Metal Affinity Chromatography) media. The novel chromatography media enables high dynamic binding capacity as well as high purity of the sample proteins purified on the media of the invention.

### BACKGROUND OF THE INVENTION

Immobilized metal chelate chromatography (IMAC) has been used as a technique for protein purification for several years. The principle behind IMAC lies in the fact that many transition metal ions can form coordination bonds between oxygen and nitrogen atoms of amino acid side chains in general and of histidine, cysteine, and tryptophan, in particular. To utilise this interaction for chromatographic purposes, the metal ion must be immobilised onto an insoluble carrier. This can be done by attaching a chelating ligand to the carrier. Most importantly, to be useful, the metal ion of choice must have a significantly higher affinity for the chelating ligand than for the compounds to be purified. Examples of suitable coordinating metal ions are Cu(II), Zn(II), Ni(II), Ca(II), Co(II), Mg(II), Fe(III), Al(III), Ga(III), Sc(III) etc. Various chelating groups are known for use in IMAC, such as irninodiacetic acid (IDA) (Porath et al. Nature, 258, 598-599, 1975), which is a tridentate chelator, and nitrilotriacetic acid (NTA) (Hochuli et al., J. Chromatography 411, 177-184, 1987), which is a tetradentate chelator.

In the field of IMAC much effort has been placed on providing an adsorbent with a high adsorption capacity for recombinant target proteins, e.g. proteins which contain extra histidine residues, so called histidine-tagged proteins. However, the cells and the fermentation broth wherein the recombinant target protein is produced will also contain other proteins produced by the host cell, generally denoted host cell proteins, some of which will also bind to the adsorbent. Thus, there is a need in this field of an IMAC adsorbent, which adsorbs less host cell proteins and/or which presents an improved selectivity allowing selective binding and/or elution of target proteins.

There are several potential advantages that in theory could be attributed to pentadentate chelating ligands. All protein binding to the metal ion should be weakened compared to tri- and tetra-dentate ligands since the number of coordination sites available for a protein molecule is lower, to the extent that most non-tagged proteins may not bind, leading to higher selectivity for histidine-tagged proteins. This could be of particular importance for low-level target protein expression, where competitive displacement of weak, unwanted binders by the strongest binder, namely the histidine-tagged protein, is difficult to use to an advantage at purification. Furthermore, the stronger binding of metal ions will decrease the loss of the ions during chromatography, decrease the risk for contamination of the purified protein with traces of metal ions, and make the chromatography resin reusable without the need for re-charging of metal ions before the next use. Such aspects are especially important for feeds (samples applied to the chromatographic column) like animal cell culture media and buffers that are “aggressive”, i.e., that tend to remove the immobilized metal ions. Also when substances that disturb the purification by interacting with the metal ions are present in feeds and/or buffers, e.g. some disulfide-reducing agents, it should be an advantage to use IMAC resins that have a pentadentate chelator.

U.S. Pat. No. 6,441,146 (Minh) relates to pentadentate chelator resins, which are metal chelate resins capable of forming octahedral complexes with polyvalent metal ions with five coordination sites occupied by the chelator, leaving one coordination site free for interaction with target proteins. It is suggested to use the disclosed chelator resins as universal supports for immobilizing covalently all proteins, using a soluble carbodiimide. More specifically, the disclosed pentadentate chelator resin is prepared by first reacting lysine with a carrier, such as activated Sepharose. The resulting immobilized lysine is then carboxylated into a pentadentate ligand by reaction with bromoacetic acid.

McCurley & Seitz (Talanta [1989] 36, 341-346: “On the nature of immobilized tris(carboxymethyl)ethylenediamine”) relates to immobilized pentadentate chelator, namely tris(carboxymethyl)ethylenediamine, also known as TED, used as IMAC stationary phases for protein fractionation. The TED resins were obtained by immobilization of ethylene diamine to a carbohydrate support, and subsequent carboxylation to provide the chelating carboxylic groups. The experimental evidence in the article shows that TED-resins prepared accordingly appear to have a mixture of ligands, with ethylenediamine-N,N′-diacetic acid (EDDA), not TED, predominant. The article also reports a large discrepancy between theoretical metal ion binding capacity determined from the nitrogen content and the experimental capacities, which indicate that a large proportion of the ligands are in a form that does not bind metal ions.

EP 2164591B1 describes production of a biomolecule adsorbent, comprising the steps of providing an alkylene diamine tetraacetic acid dianhydride, and coupling thereof to a carrier to form pentadentate ligands comprised of alkylene diamine triacetic acid linked to said carrier via an amide linkage and a spacer, and the further step of charging the adsorbent so obtained with metal ions. The pentadentate ligand forms very stable metal chelates, which at the same time provide highly selective binding properties for certain polypeptides or proteins in purification and/or detection processes.

In spite of the existing IMAC medias there is still a need for improvements in respect of capacity and purity.

### SUMMARY OF THE INVENTION

The present invention provides a novel IMAC medium of universal utility with high dynamic binding capacity without compromising sample purity.

In a first aspect, the invention relates to an IMAC (immobilized metal affinity chromatography) medium, comprising a pentadentate ligand coupled to a 5-60 μm diameter chromatography bead Q.

Preferably, the ligand is a pentadentate and the medium has the following formula:

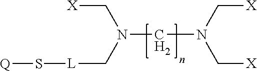

wherein
   Q is a 30-40 μm diameter chromatography bead
   S is a spacer
   L is an amide linkage
   X is COOH and n=2-3
      and wherein the dynamic binding capacity (DBC) at QB10% is more than double compared to IMAC media with larger bead size than 60 μm, preferably the QB10% is more than 3 times more, such as 6 times more.

The chromatography medium may be a porous natural or synthetic polymer, preferably agarose. In a one embodiment Q is made of agarose and the diameter of Q is 30-40 nm.

The chromatography bead Q adsorbent is charged with metal ions selected from the group that consists of Cu²⁺, Ni²⁺, Zn²⁺, Co²⁺, Fe³⁺ and Ga³⁺, preferably Ni²⁺.

In one embodiment, the chromatography beads Q may be dextran coated which increases the purify obtained by the medium as described in the Examples.

In another embodiment Q may comprises magnetic particles.

In one embodiment n is 2, i.e. ethylene in the above formula and S should preferably be a hydrophilic chain of C and O comprising at least 3 atoms.

In a second aspect, the invention relates to a method for purification of a biomolecule on an IMAC medium comprising loading a sample on a medium as described above, wherein the sample comprises chelating agents, such as EDTA, and the dynamic binding capacity at QB10% is more than double compared to conventional IMAC media. Preferably, the IMAC medium is a pentadentate medium as described above and QB10% is 3 to 6 times higher.

Preferably the biomolecule comprises two or more histidine, tryptophan and/or cysteine residues. Most preferably, the biomolecule is labelled with at least two His-residues, such as at least six His-residues. If the biomolecule is a recombinant protein, the labelling is done at the genetic level.

### BRIEF DESCRIPTION OF THE DRAWINGS

FIG. 1 Chromatogram showing a test of dynamic binding capacity (QB10%) for MBP-His of commercial HisTrap excel (bold line) versus Excel HP prototype LS018819 (dotted line). The arrows indicate 10% breakthrough during sample application. The absorbance curve at 280 nm shows later breakthrough for the prototype.

FIG. 2 Diagram of QB10% results for commercial HisTrap excel and Excel HP prototype LS018819. Sample: MBP-His.

FIG. 3 Chromatogram showing a test of dynamic binding capacity on (QB10%) for GFP-His of commercial HisTrap excel (bold line) and Excel HP prototype LS019382 (dotted line). The arrows indicate 10% breakthrough during sample application. The absorbance curve at 280 nm shows later breakthrough for the prototype, with less loss of target protein.

FIG. 4. Diagram of QB10% results for commercial HisTrap excel and Excel HP prototype LS019382. Sample: GFP-His.

FIG. 5 Purification of GFP-His in E coli lysate. Analysis by reduced SDS-PAGE (Amersham WB system). Lane 1: Start sample, Lane 2: eluted peak HisTrap excel, Lane 3: eluted peak Excel HP prototype LS019382.

FIG. 6 Purification of GFP-His in E coli lysate (eluted fractions). SDS-PAGE at reduced conditions. Lane 1: Reference (IMAC Sepharose High Performance), Lane 2: Epoxy-activated resin prototype LS018835B, Lane 3: Dextran coated resin prototype LS018835A. The separate Lane 4 shows analysis of the pre-peak obtained with the reference.

### DETAILED DESCRIPTION OF THE INVENTION

One of the main difficulties in IMAC purification is the challenge of obtaining both high purity and high capacity. High purity is often sacrified at the expense of high capacity and vice versa. There is a number of available IMAC resins, for different samples and different purposes. For example, Ni Sepharose High Performance (GE Healthcare Bio-Sciences AB) has high capacity while TALON Superflow (Clontech) has lower capacity but results in higher purity in comparison. Ni Sepharose excel is (GE Healthcare Bio-Sciences AB) a pentadentate resin which can be used for all types of samples (also metal stripping samples), results in high purity but has low capacity with loss of target protein during sample application.

A universal IMAC resin which combines all the benefits, providing high final purity, high capacity and the possibility to purify all types of samples would be very desirable.

The invention will now be described more closely in association to some non-limiting Examples and the accompanying drawings.

### Experimental

Materials and Methods

IMAC Prototypes

1. Excel HP Prototypes
LS018819 Excel ligand coupled to Sepharose High Performance, allyl content 170 mole/ml
LS019382 Excel ligand coupled to Sepharose High Performance, allyl content 189 μmole/ml
Reference column: HiTrap excel, 1 ml, GE Healthcare

2. Dextran Coated Prototypes
LS018835A Dextran coated IMAC Sepharose High Performance
Reference column: LS018835B NaOH treated epoxy activated IMAC Sepharose High Performance

The prototype resins were packed in 1 ml HiTrap columns according to the HiTrap packing method (GE Healthcare Bio-Sciences AB). A slurry concentration of 50-60% was used for packing of the HiTrap columns.

Test of Breakthrough, Purity and Resolution

Dynamic binding capacity (DBC) was tested by loading purified histidine-tagged maltose binding protein (MBP-His) and green fluorescent protein (GFP-His) to the column. Absorbance was registered and the capacity at 10% breakthrough (QB10%) of the sample absorbance was calculated.

Purity and resolution was tested by gradient purifications of GFP-His in E coli lysate. The histidine tagged protein was eluted by imidazole buffer and fractions were collected. Reduced SDS-PAGE was used for purity analysis.

Samples for Test of Dynamic Binding Capacity

Histidine(6)-tagged Green Flourescent Protein (GFP-His) in 17% glycerol, 20 mM sodium phosphate, 500 mM NaCl, pH 7.4. Concentration 2.5 mg/ml.

Histidine(6)-tagged Maltose Binding Protein (MBP-His) in 20 mM sodium phosphate, 500 mM NaCl, pH 7.4. Concentration 1.4 mg/ml.

Samples for Test of Final Purity and Resolution

Histidine(6)-tagged Green Flourescent Protein (GFP-His) in E coli, 20 mM sodium phosphate, 500 mM NaCl, pH 7.4. Concentration ˜3 mg/ml.

The samples were centrifuged (20 000 g for 10 minutes) and the supernatants were 0.45 μm filtrated when injected to the column.

Buffers

Binding buffer, A: 20 mM sodium phosphate, 500 mM NaCl, pH 7.4

Elution buffer, B: 500 mM imidazole in binding buffer

Chromatography methods

Test: Dynamic binding capacity. Excel HP prototype.
Chromatography system: ÄKTA avant A25.

| | Column | | Flow | |
|---|---|---|---|---|
| | volumes | | rate | |
| Step | (CV) | % B | (ml/min) | Comments |
| Equilibration | 5 | 0 | 1 | |
| Sample | 38 ml or 70 ml | 0 | 1 | 38 ml GFP-His or |
| application | | | | 70 ml MBP-His |
| Wash | 5 | 0 | 1 | |
| Elution | 8 | 100 | 1 | |
| Re- | 5 | 0 | 1 | |
| equilibration | | | | |

Test: Purity and resolution. Excel HP Prototype.
Chromatography system: ÄKTAavant A25.

| | Column | | Flow | |
|---|---|---|---|---|
| | volumes | | rate | |
| Step | (CV) | % B | (ml/min) | |
| Equilibration | 5 | 0 | 1 | |
| Sample | 2 ml | 0 | 1 | His-tagged protein in E coli |
| application | | | | lysate. Load: ~6 mg |
| | | | | his-tagged protein. |
| Wash | 5 | 0 | 1 | |
| Elution | 20 | 0-100 | 1 | Gradient elution |
| Re- | 4 | 0 | 1 | |
| equilibration | | | | |

Test: Purity and resolution. Dextran coated prototype.
Chromatography system: ÄKTAavant A25.

| | Column | | Flow | |
|---|---|---|---|---|
| | volumes | | rate | |
| Step | (CV) | % B | (ml/min) | |
| Equilibration | 5 | 4 | 1 | |
| Sample | 2 ml | 4 | 1 | His-tagged protein in E coli |
| application | | | | lysate. Load: ~6 mg |
| | | | | his-tagged protein. |
| Wash | 5 | 4 | 1 | |
| Elution | 20 | 4-100 | 1 | Gradient elution |
| Re- | 4 | 4 | 1 | |
| equilibration | | | | |

SDS-PAGE under reduced conditions was performed using Amersham WB system. The samples were first buffer exchanged using Amersham WB Minitrap kit.

### Experiment 1: Synthesis of the Excel HP Prototype

In this experiment the pentaligand described in EP 2164591B1 was coupled to Sepharose High Performance (GE Healthcare Bio-Sciences AB) (bead size diameter 34 μm). This bead has a smaller bead size which increases surface area for coupling compared with resins with larger bead size. The smaller bead size should also result in an increased number of repeated bindings (off-on events) in the column. This might be beneficial to decrease the leakage of target protein during sample application. The slightly larger pore size of High Performance resin compared to conventional IMAC media might also increase accessibility for the target protein.

Step 1: Allylation

120 ml Sepharose HP resin was washed with water on a glass filter (p3, 6GV) and the water sucked. The 120 g sucked resin was then transferred into a jacketed reactor along with 7.5 ml distilled water. Stirring was started and 12 ml 50% NaOH was added to the slurry. The slurry was stirred for 30 minutes and then heated to 47° C. and then 60 ml AGE was added. After ca 18 hours the stirring was stopped and the slurry transferred to a glass filter. The slurry was then washed with water (1 GV×3), the EtOH (1 GV×3) and then with water (1 GV×6).

Allyltitration (using titration) Allyl content: =170 μmol/ml for LS018819.

Allyltitration (using titration): Allyl content: 189 μmol/ml for LS019382.

Step 2: Bromination

The 100 g/ml dry sucked allylated gel was transferred into a reaction reactor followed by adding 300 ml water and 4.6 g Sodium acetate trihydrate with stirring for 5 minutes. To the reaction mixture about 5 ml Bromine was added until the colour of the gel became strongly dark yellow and the reaction was left for 5 minutes with stirring at r. t. To the reactions mixture about 7.8 g sodium formate was added and the reaction was left with stirring for 15 minutes until the yellow colour disappeared. The gel was washed with (10×1 GV) water on glass filter (P3).

Step 3: Amination Step

The 100 g brominated gel from step 2 was transferred to a reaction reactor and 150 ml ammonia solution was added and the reaction mixture was left over night at 45° C. The gel was washed with 10×1 GV on glass filter (P3).

Step 4: EDTA Ligand Coupling Step

The 100 g aminated gel from step 3 was washed with 6×1GV Acetone and transferred into the reaction reactor and 100 ml Acetone was added. To the reaction mixture 2.9 g DIPEA was added and the reaction was left for 5 minutes with stirring. 5.3 g EDTA was added to the reaction mixture and the mixture was left overnight at 24-28° C. The gel was washed with 3×1GV Acetone followed by 3×1GV water. The sucked gel was transferred in to the reactor and 1 GV 2M NaOH was added to hydrolyse the access of unreacted EDTA. The gel was washed on glass filter (P3) with 6×1GV.

The gel was finally nickel loaded with 0.1 M nickel sulphate.

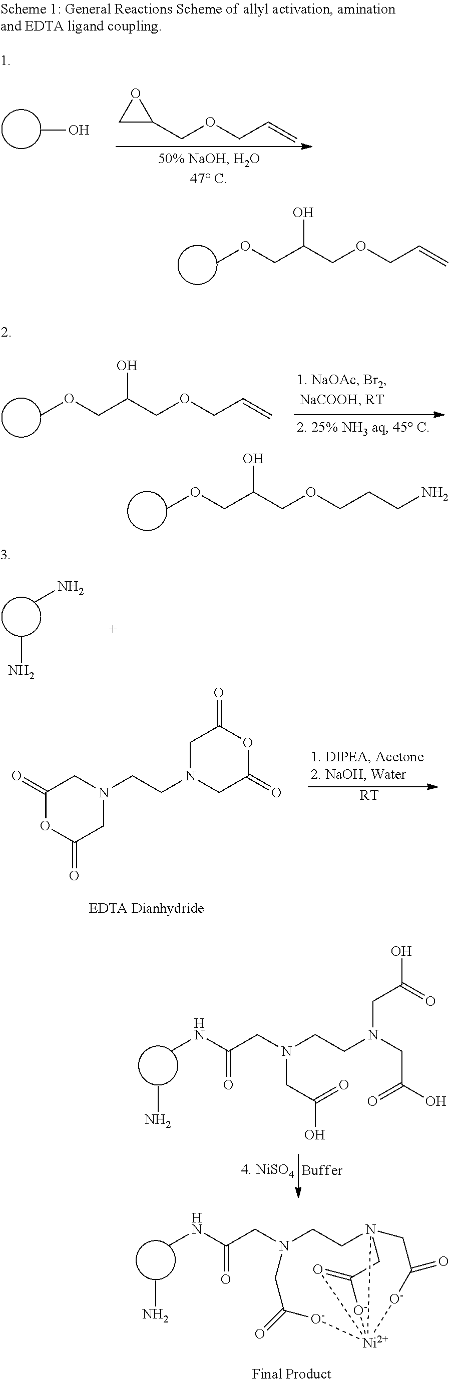

Dynamic Binding Capacity

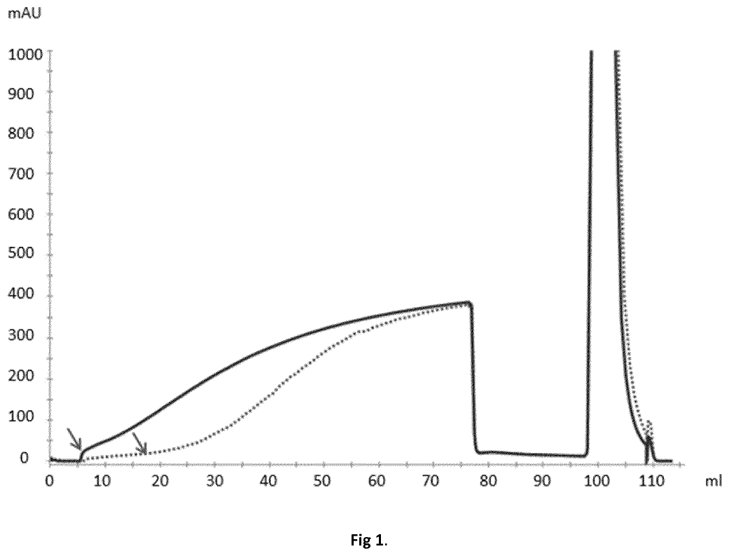

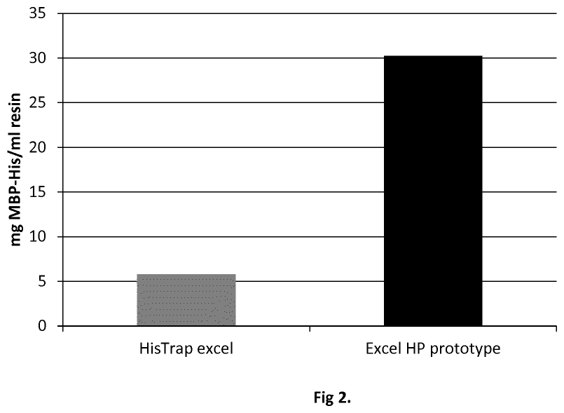

The dynamic binding capacity, DBC, was tested using two different purified histidine-tagged proteins (MBP-His and GFP-His) and was calculated at 10% breakthrough, QB10%. The loss of the weak binding MBP-His started almost immediately from commercial HisTrap excel while a delay was detected for the Excel HP prototype LSOI 8819 (FIG. 1). The calculated QB10% was about 5 mg LS018819 MBP-His/ml resin for HisTrap excel and about 30 mg MBP-HisimIresin for the prototype (FIG. 2). Thus, the QB10% was about 6 times better for the prototype.

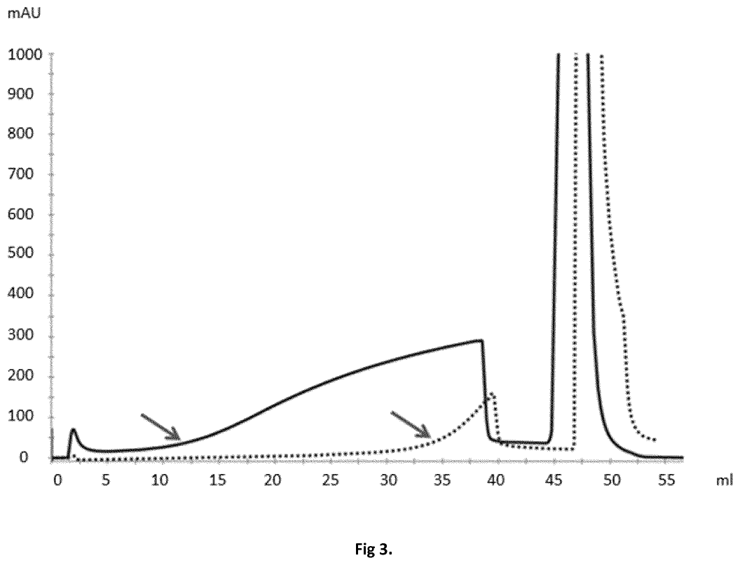

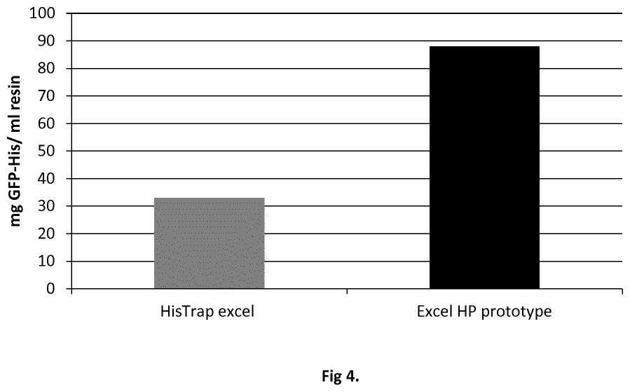

A later breakthrough can be expected for the strong-binding GFP-His compared with the weak-binding MBP-His. The obtained QB10% for HisTrap excel was 30 mg GFP-His/ml resin. The Excel HP prototype LS019382 showed further improvement in performance. The absorbance was very low (0 mAii) with no loss of target protein until the end of sample application (FIG. 3). The calculated QB10% was 90 mg GFP-His/ml resin (FIG. 4).

Purity

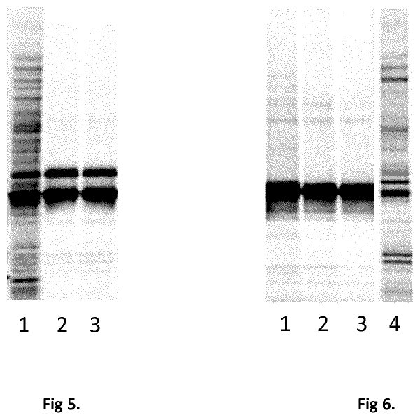

High capacity for histidine-tagged proteins may also result in high capacity for impurities containing one or several histidines. The final purity was investigated by adding a sample of GFP-His in E coli lysate to the columns. Low load was used in order to leave free coordination sites left for the impurities to bind. The sample was applied without any imidazole added, and eluted by an imidazole gradient. The eluted peaks were analyzed by reduced SDS-PAGE (FIG. 5). The reason for two major bands in the lanes 1-3 of FIG. 5 can probably be explained by a known truncation of GFP-His (still having the histidine-tag left). The final purity was equal for the two resins.

Thus, the results show that equal purity was obtained despite the higher capacity of the Excel HP prototype. This could be explained by the fact that the excel ligand is a pentadentate with only one coordination site left for binding to the protein. The six histidine-tag may be beneficial with improved chances to bind to the only coordination site compared with single histidines distributed along the impurity proteins. The results show that both high capacity and high purity was obtained using the Excel HP prototype.

In comparison with the current Ni Sepharose excel product the prototype resulted in 3-6 times higher dynamic capacity with significantly lower loss of target protein during sample application. The reason for the increased capacity might be due to the increased surface of Sepharose High Performance (bead size 34 urn) in comparison with Sepharose Fast Flow (bead size 90 μm) and other effects like accessibility due to larger pore size and increased numbers of repeated binding in the column.

### Experiment 2: Synthesis of the Dextran Coated Prototype

The purpose of dextran coating was to prevent multipoint attachment of impurities containing one or several histidines, while maintaining the binding of histidine tagged proteins. (New dextran-coated immobilized metal ion affinity chromatography matrices for prevention of undesired multipoint adsorptions, Journal of Chromatography A, 915 (2001) 97-106.) The tetradentate IMAC Sepharose High Performance (GE Healthcare Bio-Sciences AB) was used in this case but the results should also be applicable for pentadentate resins.

To evaluate the dextran effect two prototypes were made. One with Dextran coupled to LS 018835A it and one control prototype LS018835B which was only treated with NaOH to hydrolyse the epoxy groups.

Step 1: Epoxy Activation

Approximately 100 ml slurry of the gel (IMAC Sepharose High Performance) was washed with water (5×1GV) on a glass filter. The gel was then sucked dry and 50 g was weighed into a 250 ml three-necked flask for epoxy activation. To the flask was then added 12 ml water and stirring and heating to 28° C. was started. During stirring 8 ml of 50% NaOH was added and the slurry was then stirred at 28° C. for about 10 minutes after which Epichlorohydrine (12.5 ml) was added and then left with stirring for 3.5 hours. The gel was then washed with water (6×1GV) on a glass filter.

Epoxy titration (60 minutes titration, method 018 BL5-3) gave an epoxide content of around 16 μmol/ml for the epoxide activated gel that was used in the couplings.

Step 2: Dextran Coupling Step Prototype LS018835A

8 g Dextran TF (10% Dx TF) was dissolved in a Duran flask with 35.2 ml water during rotation stirring for approximately 3 hours. 40 g of drained epoxyactivated gel from above was then added to the flask and the slurry was then heated to 40° C. and rotation stirred for 60 minutes. To the flask was then added 4.8 ml 50% NaOH and 0.1 g NaBH4 and then left with stirring by rotation at 40° C. overnight. The gel was washed with water (10×1 GV).

Step 3: NaOH Treatment of Epoxy Activated Gel Prototype LS018835B

10 g of drained epoxyactivated gel from above was added to a 50 ml Falcon tube along with 8.8 ml dest water and shaken to a homogenous slurry. To the tube was then added 1.2 ml 50% NaOH and 0.05 g NaBH4. The tube was then put on a shaking table and heated to 40° C. and left shaking overnight.

After approximately 18.5 hours the reactions were stopped and the slurries washed with water (approximately 10×2GV) on a glass filter (p3). The resins were finally nickel loaded with 0.1 M nickel sulfate.

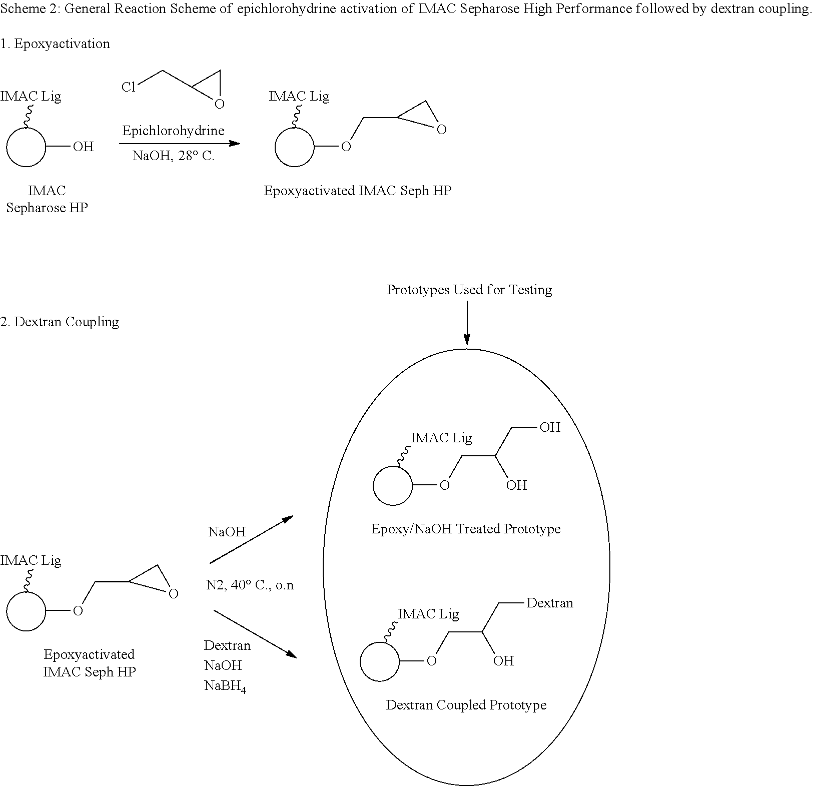

Dry Weight Analysis

The dry weight of the prototypes was measured using standard method (120° C. drying temperature).

| | | Dry weight |
|---|---|---|
| | Dry weight | increase |
| Prototype | (mg/ml) | (mg/ml) |
| IMAC Seph HP | 79 | — |
| LS018835A | 84.1 | 5.1 |
| LS018835B | 79.7 | 0.7 |

As can be seen in the table approximately 5 mg/ml of dextran has been coupled to the media. A small increase in dry weight can also be seen for the NaOH treated B prototype.

Purity and Dynamic Binding Capacity

As described above a dextran layer of ˜10% was added to epoxy-activated IMAC Sepharose High Performance. The sample was GFP-His in E coli lysate and elution was performed using an imidazole-gradient. According to the chromatograms a pre-peak with absorbance at 280 nm was detected for the reference but not the dextran coated prototype LS018835A (not shown). The pre-peak lacked absorbance at 490 nm (specific for GFP-His) which indicated a content of contaminants. The eluted samples were analyzed by reduced SDS-PAGE (FIG. 6). The results show higher purity for the dextran coated resin but also the epoxy-activated resin LS018835B had higher purity in comparison with the reference. Thus, both prototypes had clearly better purity properties than the reference.

1. An immobilized metal affinity chromatography (IMAC) medium, comprising a pentadentate ligand coupled to a 5-60 μm diameter chromatography bead Q.

2. The IMAC medium according to claim 1, wherein the ligand is a pentadentate and the medium has the following formula: 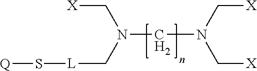
wherein
Q is a chromatography bead
S is a spacer
L is an amide linkage
X is COOH
n=2-3
and wherein the dynamic binding capacity (DBC) at QB10% is more than double compared to IMAC media with larger bead size than 60 μm.

3. The medium according to claim 2, wherein the QB10% is at least 3 times more.

4. The medium according to claim 1, wherein Q is a porous natural or synthetic polymer, preferably agarose.

5. The medium according to claim 1, wherein Q is made of agarose and the diameter of Q is 30-40 μm.

6. The medium according to claim 1, wherein Q is dextran coated.

7. The medium according to claim 2, wherein n is 2, i.e. ethylene and S should preferably be a hydrophilic chain of C and O comprising at least 3 atoms.

8. The medium according to claim 2, wherein the Q adsorbent is charged with metal ions selected from the group that consists of Cu2+, Ni2+, Zn2+, Co2+, Fe3+ and Ga3+.

9. The method according to claim 1, wherein Q comprises magnetic particles.

10. A method for purification of a biomolecule on an IMAC medium comprising loading a sample on a medium according to one or more of the above claims, wherein the sample comprises chelating agents, such as EDTA, and the dynamic binding capacity at QB10% is more than double compared to conventional IMAC media.

11. The method according to claim 10, wherein the IMAC medium is a pentadentate medium of and QB10% is 3 to 6 times higher.

12. The method according to claim 10, wherein the biomolecule is labelled with at least two, preferably at least six, His-residues.

13. An IMAC medium comprising a tetra or pentadentate ligand coupled to a chromatography bead made of agarose and comprising an outer layer of dextran.
